(19) United States
(12) Patent Application Publication
(10) Pub. No.: US 2025/0324349 A1
(43) Pub. Date: Oct. 16, 2025

(54) METHOD AND DEVICE FOR PERFORMING COMMUNICATION IN WIRELESS COMMUNICATION SYSTEM

(71) Applicant: LG Electronics Inc., Seoul (KR)

(72) Inventors: Eunjong LEE, Seoul (KR); Kyungho LEE, Seoul (KR); Bonghoe KIM, Seoul (KR); Sangrim LEE, Seoul (KR)

(21) Appl. No.: 18/714,774

(22) PCT Filed: Nov. 23, 2022
(86) PCT No.: PCT/KR2022/018615

§ 371 Date: Aug. 28, 2024

(30) Foreign Application Priority Data
Nov. 30, 2021 (KR) 10-2021-0169015

(51) Int. Cl. H04W 48/08; H04W 72/231; H04W 72/232

(52) U.S. Cl. CPC H04W 48/08; H04W 72/231; H04W 72/232

(57) ABSTRACT

In the present disclosure, a method for operating a terminal in a wireless communication system may receiving, by the terminal, an MIB from a base station, obtaining a first system information block based on the received MIB, obtaining a second system information block based on the first system information block, and performing communication with the base station based on the second system information block. Herein, the second system information block may include AI/ML model group information and message information associated with an AI/ML model group.

### TECHNICAL FIELD

The present disclosure relates to a wireless communication system, and more particularly, to a method and device for performing communication in a wireless communication system. Especially, the present disclosure relates to a method and device for sharing an artificial intelligence (AI)/machine learning (ML) model.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### DISCLOSURE

### Technical Problem

The present disclosure relates to a method and device for performing communication in a wireless communication system.

The present disclosure relates to a method and device for sharing an AI/ML model in a wireless communication system.

The present disclosure relates to a method and device for sharing AI/ML model information and update information by a base station with a terminal in a wireless communication system.

The present disclosure relates to a method and device for configuring a message with a layered structure to indicate AI/ML model information in a wireless communication system.

The present disclosure relates to a method and device for providing AI/ML model information based on an AI/ML model group in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

### Technical Solution

As an example of the present disclosure, a method for operating a terminal in a wireless communication system may include receiving, by the terminal, a master information block (MIB) from a base station, obtaining a first system information block based on the received MIB, obtaining a second system information block based on the first system information block, and performing communication with the base station based on the second system information block. Herein, the second system information block includes artificial intelligence (AI)/machine learning (ML) model group information and message information related to an AI/ML model group.

In addition, as an example of the present disclosure, a method for operating a base station in a wireless communication system may include transmitting, by the base station, a master information block (MIB), transmitting a first system information block based on the MIB, transmitting a second system information block based on the first system information block, and performing communication with a terminal based on the second system information block. Herein, the second system information block may include artificial intelligence (AI)/machine learning (ML) model group information and message information related to an AI/ML model group.

In addition, as an example of the present disclosure, a terminal in a wireless communication system may include a transceiver and a processor coupled with the transceiver, and the processor may be configured to receive a master information block (MIB) from a base station by using the transceiver, to obtain a first system information block based on the received MIB by using the transceiver, to obtain a second system information block based on the first system information block by using the transceiver, and to perform communication with the base station based on the second system information block. Herein, the second system information block may include artificial intelligence (AI)/machine learning (ML) model group information and message information associated an AI/ML model group.

In addition, as an example of the present disclosure, a base station in a wireless communication system may include a transceiver and a processor coupled with the transceiver, and the processor may be configured to transmit a master information block by using the transceiver, to transmit a first system information block based on the MIB by using the transceiver, to transmit a second system information block based on the first system information block by using the transceiver, and to perform communication with a terminal based on the second system information block. Herein, the second system information block may include artificial intelligence (AI)/machine learning (ML) model group information and message information related to an AI/ML model group.

In addition, as an example of the present disclosure, in a device including at least one memory and at least one processor functionally coupled with the at least one memory, the at least one processor may control the device to receive a master information block (MIB) from a base station, to obtain a first system information block based on the received MIB, to obtain a second system information block based on the first system information block, and to perform communication with the base station based on the second system information block. Herein, the second system information block may include artificial intelligence (AI)/machine learning (ML) model group information and message information associated with an AI/ML model group.

In addition, as an example of the present disclosure, a non-transitory computer-readable medium storing at least one instruction may include the at least one instruction that is executable by a processor, and the at least one instruction may be configured to receive a master information block (MIB) from a base station, to obtain a first system information block based on the received MIB, to obtain a second system information block based on the first system information block, and to perform communication with the base station based on the second system information block, and the second system information block may include artificial intelligence (AI)/machine learning (ML) model group information and message information associated with an AI/ML model group.

In addition, the following may commonly apply.

As an example of the present disclosure, AI/ML model group information included in a second system information block may include at least any one of AI/ML model group number information, update indication information per AI/ML model group, valid area information per AI/ML model group, and resource scheduling information for a message related to an AI/ML model group.

In addition, as an example of the present disclosure, an AI/ML model group number may be equal to the number of the message related to the AI/ML model group, and the update indication information per AI/ML model group may be set to 1 bit for each AI/ML mode group and thus be set to a bit corresponding to the AI/ML model group number.

In addition, as an example of the present disclosure, the valid area information per AI/ML model group may be indicated based on at least any one of a public land mobile network (PLMN), a cell group area, and a cell.

In addition, as an example of the present disclosure, in case a terminal moves into a cell, the terminal may determine a valid area for each AI/ML model group, and in case at least one AI/ML model group among the AI/ML model groups is outside a valid area, the terminal may update only the at least one AI/ML model group that is outside the valid area.

In addition, as an example of the present disclosure, the resource scheduling information for the message related to the AI/ML model group may include at least any one of transmission window information and transmission occasion information in which the message related to the AI/ML model group is transmitted, wherein a size of a transmission window is indicated based on the transmission window information, and a transmission period and a transmission offset value may be indicated based on the transmission occasion information.

In addition, as an example of the present disclosure, a terminal receives a message related to at least one or more AI/ML model groups based on the message information related to the AI/ML model group, wherein the message related to the AI/ML model group may include at least any one of the number of AI/ML models in the AI/ML model group, an index of each AI/ML model in the AI/ML model group, and feedback information related to AI/ML model performance.

In addition, as an example of the present disclosure, based on an index of each AI/ML model in an AI/ML model group, the each AI/ML model and a radio resource control (RRC) information element (RE) may be connected.

In addition, as an example of the present disclosure, an AI/ML model group may be grouped based on at least any one of performance evaluation data, an AI/ML model type, an AI/ML model coefficient quantization level, an AI/ML model procedure, and AI/ML capability and AI/ML version.

In addition, as an example of the present disclosure, in case a terminal performs initial access, the terminal may obtain an MIB and a first system information block, and in case a second system information block is broadcast, the terminal may obtain the second system information block based on the first system information block, and in case the second system information block is not broadcast, the terminal may obtain the second system information block based on an on-demand request.

In addition, as an example of the present disclosure, in case a terminal receives at least any one of a short message and downlink control information (DCI) after receiving AI/ML model information, the terminal may receive a second system information block, and the short message and the DCI may include information indicating AI/ML model update.

In addition, as an example of the present disclosure, the information indicating the AI/ML model update may be configured according to each AI/ML model group.

### Advantageous Effects

As is apparent from the above description, the embodiments of the present disclosure have the following effects.

The embodiments of the present disclosure may provide a method for sharing an AI/ML model.

The embodiments of the present disclosure may provide a method for sharing artificial intelligence (AI)/machine learning (ML) model information and update information by a base station with a terminal.

The embodiments of the present disclosure may configure a message with a layered structure in order to indicate AI/ML model information.

The embodiments of the present disclosure may provide AI/ML model information based on an AI/ML model group.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure.

That is, effects, which are not intended when implementing a configuration described in the present disclosure, may also be derived by those skilled in the art from the embodiments of the present disclosure.

### DESCRIPTION OF DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 is a view illustrating an example of a communication system applicable to the present disclosure.

FIG. 2 is a view illustrating an example of a wireless apparatus applicable to the present disclosure.

FIG. 3 is a view illustrating another example of a wireless device applicable to the present disclosure.

FIG. 4 is a diagram illustrating an example of an AI device applied to the present disclosure.

FIG. 5 is a view illustrating a functional framework according to an embodiment of the present disclosure.

FIG. 6 is a view illustrating a method of generating an AI/ML-based model inference output according to an embodiment of the present disclosure.

FIG. 7 is a view illustrating a method of generating an AI/ML-based model inference output according to an embodiment of the present disclosure.

FIG. 8 is a view illustrating a case where both model training and model inference exist in a RAN, according to an embodiment of the present disclosure.

FIG. 9 is a view illustrating a method of performing AI/ML-based model training in a network and model inference in a terminal, according to an embodiment of the present disclosure.

FIG. 10 is a view illustrating a method of performing AI/ML-based model training in a network and model inference in a network and a terminal, according to an embodiment of the present disclosure.

FIG. 11 is a view illustrating a method of transmitting a first message according to an embodiment of the present disclosure.

FIG. 12 is a view illustrating a method of transmitting an AI/ML model group-based message according to an embodiment of the present disclosure.

FIG. 13 is a view illustrating a method of obtaining AI/ML model information with a terminal initially entering a cell according to an embodiment of the present disclosure.

FIG. 14 is a view illustrating an operation of receiving updated AI/ML model information by a terminal that has received AI/ML model information once, according to an embodiment of the present disclosure.

FIG. 15 is a view illustrating an operation of a terminal according to an embodiment of the present disclosure.

FIG. 16 is a view illustrating an operation of a base station according to an embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.Xxx Release 8. In detail, LTE technology after 3GPP TS 36.XXX Release 10 may be referred to as LTE-A, and LTE technology after 3GPP TS 36.XXX Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

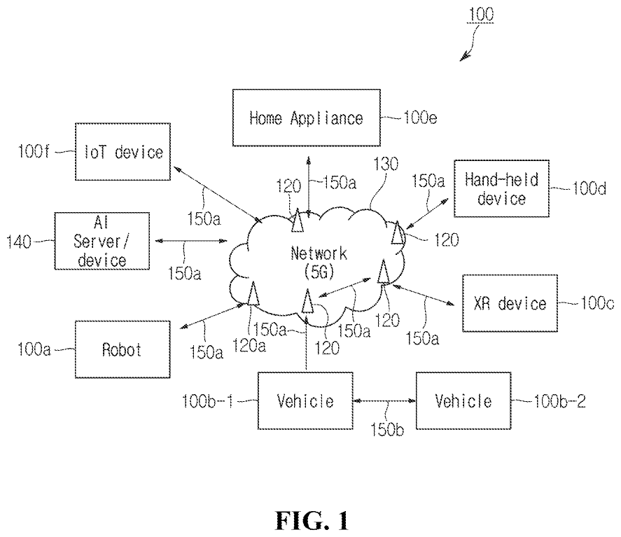

FIG. 1 is a view illustrating an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

### Communication System Applicable to the Present Disclosure

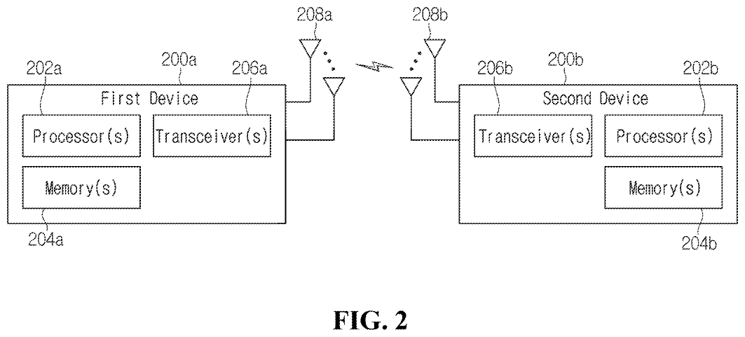

FIG. 2 is a view illustrating an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

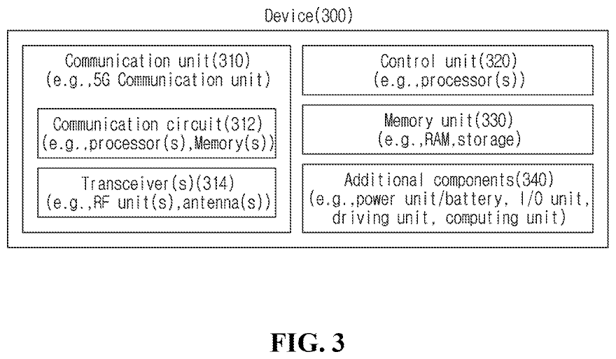

FIG. 3 is a view illustrating another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330) and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1. 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330) may be composed of a random access memory (RAM), a dynamic RAM (DRAM), a read only memory (ROM), a flash memory, a volatile memory, a non-volatile memory and/or a combination thereof.

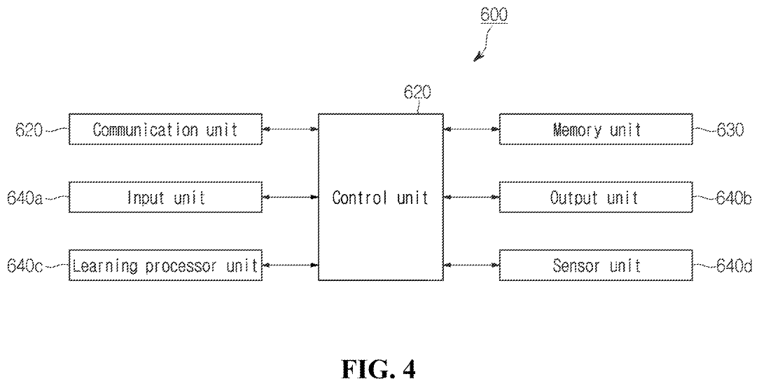

FIG. 4 is a diagram illustrating an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 4, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

Hereinafter will be described a method for configuring a functional framework based on an AI/ML model.

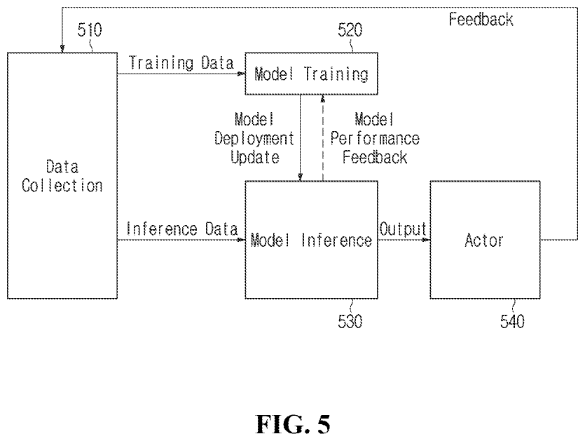

FIG. 5 is a view illustrating a functional framework. Communication may be performed based on AI.ML-enabled RAN intelligence. As an example, an AI/ML algorithm may be configured in various forms. Referring to FIG. 5, based on an AI/ML model that is preconfigured according to an AI/ML algorithm, an AI/ML-based operation may be performed according to AI/ML functionality and corresponding inputs and outputs.

Specifically, a data collection entity 510 may provide input data to a model training entity 540 and a model inference entity 520.

The input data may include at least any one of a measured value from another network entity, a feedback value from terminals, and a feedback value for an output of the AI/ML model. Training data, which the data collection entity 510 provides to the model training entity 540, may be data that is provided for an AI/ML model training function. In addition, inference data, which the data collection entity 510 provides to the model inference entity 520, may be data that is provided for an AI/ML model inference function. Herein, the model training entity 540 may be an entity that performs training, validation and testing of an AI/ML model.

The model training entity 540 may provide an AI/ML model to the model inference entity 520 and update the AI/ML model. In addition, the model inference entity 520 may provide model performance feedback to the model training entity 540. That is, the model training entity 540 may perform training for the AI/ML model through the feedback of the model inference entity 520 and provide the updated AI/ML model to the model inference entity 520 again. In addition, the model inference entity 520 may receive inference data from the model collection entity 510. Herein, the model inference entity 520 may generate an output through the provided AI/ML model and provide the output to an actor entity 530. Herein, the actor entity 530 may be an agent that performs an operation according to the output, and feedback on the operation performed by the actor entity 530 may be given to the data collection entity 510 again. In addition, the feedback information may be provided in turn to the model training entity 540 as training data.

That is, as data for training for an AI/ML model is provided, the AI/ML model may be trained and constructed, and as inference data is provided to the AI/ML model and is output, an operation based on the AI/ML model may be performed.

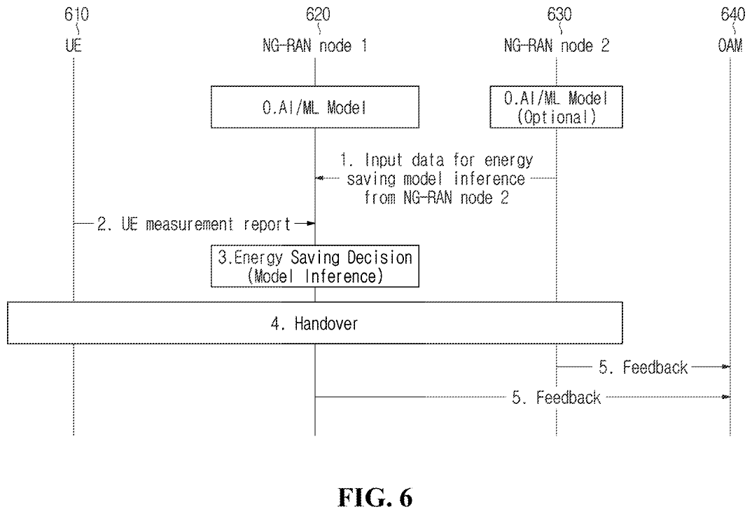

As a concrete example, FIG. 6 is a view illustrating a method of generating an AI/ML-based model inference output applicable to the present disclosure. Referring to FIG. 6, an NG-RAN node 1 620 may have an AI/ML model. Herein, a model inference of FIG. 5 may exist in the NG-RAN node 1 620, and training may be performed in OAM 640. That is, training for the AI/ML model may not performed in the RAN node, and the RAN node may have only the model inference. Herein, the NG-RAN node 1 620 may receive data for AI/ML model inference as required input data based on network energy saving from an NG-RAN node 2 630. As an example, the NG-RAN node 2 630 may have a model inference for the AI/ML model, which may not be necessary. Then, the NG-RAN node 1 620 may obtain measurement information from a terminal 610. The NG-RAN node 1 620 may generate an output for the model inference based on the measurement data obtained from the terminal 610 and the data obtained from the NG-RAN node 2 630. As an example, the output for the model inference may be an energy saving strategy or a handover strategy. That is, the NG-RAN node 1 620 may perform a handover for the terminal or other operations based on the model inference output but is not limited to a specific embodiment. Then, at least any one of the NG-RAN node 1 620 and the NG-RAN node 2 630 may deliver feedback to the OAM 640, and training may be performed in the OAM 640) based on the feedback.

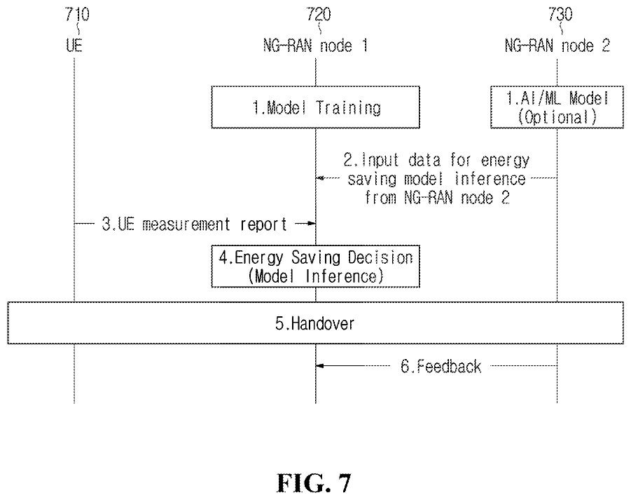

In addition, FIG. 7 is a view illustrating a method of generating an AI/ML-based model inference output applicable to the present disclosure. Referring to FIG. 7, unlike FIG. 6, an NG-RAN node 1 720 may perform model training on its own. Specifically, the NG-RAN node 1 720 may receive data for an AI/ML model inference as required input data from another NG-RAN node 2 730 based on network energy saving. As an example, the NG-RAN 2 730 may also have a model inference for an AI/ML model, which may not be necessary. Then, the NG-RAN node 1 720 may obtain measurement information from a terminal 710. The NG-RAN node 1 720 may generate an output for the model inference based on the measurement data obtained from the terminal 710 and the data obtained from the NG-RAN 2 730. As an example, the output for the model inference may be an energy saving strategy or a handover strategy. That is, the NG-RAN node 1 7620 may perform a handover for the terminal or other operations based on the model inference output but is not limited to a specific embodiment. Then, the NG-RAN node 1 720 may perform training on its own because the NG-RAN node 1 720 has model training. To this end, the NG-RAN node 1 720 may obtain feedback information from the NG-RAN node 2 730 and perform training on its own through the feedback information.

Herein, as an example, for AI/ML-based optimized network energy saving, an NG-RAN may need input data for AI/ML-based network energy saving. As an example, the input data may include at least any one of a current or expected resource status of a cell and a neighbor node, current or expected energy information of the cell and the neighbor node, and a terminal measurement report (e.g. UE RSRP, RSRQ, SINR measurement, etc.).

In addition, in case a gNB needs an existing terminal measurement for AI/ML-based network energy saving, a RAN may reuse an existing framework (including MDT and RRM measurements) and is not limited to a specific embodiment.

In addition, as an example, output information for AI/ML-based network energy saving may include at least any one of an energy saving strategy, a handover strategy including a recommended candidate cell for traffic takeover, and predicted energy information, but is not limited thereto.

In addition, as an example, performance of a model may be optimized for AI/ML-based network energy saving. To this end, a RAN node may obtain at least any one of load measurement information and energy information but may not be limited thereto.

In addition, as an example, an AI/ML model may be considered for load balancing. Specifically, rapid traffic growth and multiple frequency bands utilized in a commercial network make it challenging to steer traffic distribution, and an AI/ML model may be considered for load balancing. Load balancing may be to evenly distribute loads among cells or among cell areas, transfer part of traffic from congested cells or congested areas of cells, or perform offloading actions.

Herein, the load balancing may be performed through optimization of handover parameters and handover actions. However, the traffic load and resource status of the network may cause degradation of service quality in case that a plurality of high-mobility terminals are connected. Accordingly, it may be difficult to guarantee the overall network and service performance when performing load balancing, and in this regard, application of an AI/ML model may be considered.

As an example, when AI/ML-based load balancing is supported, model training may be located in OAM, and model inference may exist in a base station. As another example, both model training and model inference may exist in a base station. Herein, as an example, in a base station based on central unit (CU)-distributed unit (DU) architecture, model training may exist in OAM, and model inference may exist in a gNB-CU. As another example, both model training and model inference may exist in the gNB-CU. As another example, model training and model inference may exist in various locations and are not limited to a specific embodiment.

As an example, in order to improve a load balancing decision in a gNB (gNB-CU), the gNB may request a load prediction to a neighbor node. For AI/ML-based load balancing, if an existing terminal measurement is needed in a gNB, a RAN may reuse an existing framework (including MDT and RRM measurements) but may not be limited thereto.

As another example, an AI/ML model may be considered for mobility optimization. Mobility management may be a scheme to guarantee service-continuity during mobility by minimizing call drops. RLFs, unnecessary handovers, and ping-pong. For a high-frequency network, as the coverage of a single node decreases, the frequency for a terminal to handover between nodes may become higher. Especially for a high-mobility terminal, the handover frequency is more likely to become higher. Herein, for an application characterized with the stringent QoS requirements such as reliability, latency etc., the QoE is sensitive to handover performance, so that mobility management needs to avoid unsuccessful handover and to reduce latency during a handover procedure, and in this regard, an AI/ML model may be considered. As an example, by using AI/ML, at least any one of reduction of probability of unintended events, terminal location/mobility/performance prediction, and traffic steering may be performed. Herein, as an example, the unintended events may be too late handover, too early handover, and handover of a terminal to another cell in an intra system, but may not be limited thereto.

In addition, as an example, the terminal location/mobility/performance prediction may be performed by determining a best mobility target for maximization of efficiency and performance. The traffic steering may mean adjusting a handover trigger point based on efficient resource handling and selecting an optimal combination of cells to serve user.

That is, an AI/ML model may be needed in consideration of the above-described operation. Herein, it is possible to consider a case where based on the AI/ML model, model training is deployed in OAM and model inference exists in a RAN, which may be the same as the above-described FIG. 6. In addition, as an example, based on the AI/ML model, both model training and model inference may exist in a RAN, which may be the same as FIG. 7. As another example, in a CU-DU split scenario, model training may be located in CU-CP or OAM, and model inference may be located in CU-CP, but may not limited thereto.

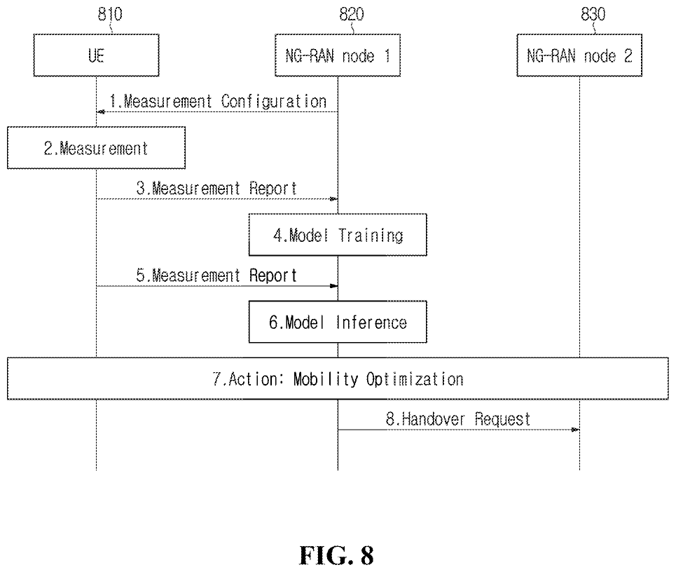

In addition, as an example. FIG. 8 is a view illustrating a case where both model training and model inference, which are applicable to the present disclosure, exist in a RAN. Referring to FIG. 8, an NG-RAN node 1 820 may have both model training and model inference. Herein, the NG-RAN node 1 820 may provide measurement configuration information to a terminal 810, and the terminal 810 may perform measurement based on the measurement configuration information and deliver a measurement report to the NG-RAN node 1 820. Then, the NG-RAN node 1 820 may perform model training. As another example, the NG-RAN node 1 820 may perform model inference based on the measurement report received from the terminal 810 and thus derive an output. Herein, as described above, the output may be an operation for load balancing or mobility optimization. As an example, based on a model inference output, the NG-RAN node 1 820 may request handover to the NG-RAN node 2 830 or request other operations to be performed but is not limited to a specific embodiment.

Based on what is described above, an AI/ML-based operation may be performed in a new communication system (e.g. 6G). As an example, the AI/ML technology may be applied not only to network technology but also to CSI feedback enhancement, beam management, positioning, RS overhead reduction, and RRM mobility enhancement, but may not be limited to a specific field. As an example, AI/ML may be applied to enhancing the technical field of PHY layers and MAC/RRC layers between a terminal and a base station, and a method for this will be described below.

Herein, as an example, scenarios for enhancement in an air interface such as RAN1/RAN2 may be shown in Table 2 below. Specifically, it is possible to consider a scenario (case 1) where performance is enhanced by implementing an AI/ML model in at least one of a network and a terminal, a scenario (case 2) where performance is enhanced by implementing an AI/ML model independently in at least one of a network and a terminal and defining input/output, and a scenario (case 3) where performance is enhanced by sharing an AI/ML model that is implemented in a network or a terminal. Herein, as an example, hereinafter will be described a method of performing model training and model inference based on the scenario of case 3 that enhances performance by sharing an AI/ML model implemented in a network or a terminal. Specifically, the scenario may be a scenario where model training is performed in a network and model inference is performed in a terminal or both in the terminal and in a network at once, but may not be limited thereto.

TABLE 2
- Case 1 : performance enhancement through implementation of an AI/ML
model in NW and/or terminal
- Case 2 : performance enhancement through definition of input/output
and independent implementation of an AI/ML mode in NW and/or
terminal
- Case 3 : performance enhancement through sharing of an AI/ML model
implemented in NW or terminal

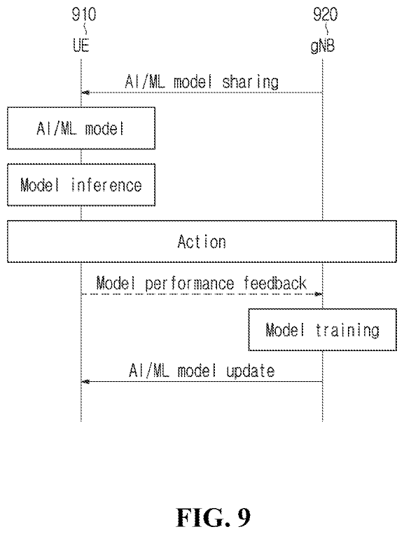

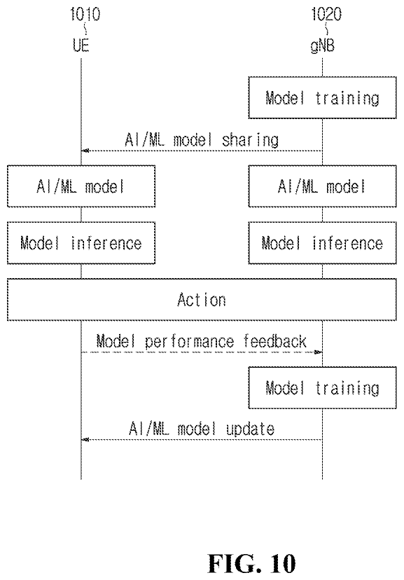

Herein, FIG. 9 is a view illustrating a method of performing AI/ML-based model training, which is applicable to the present disclosure, in a network and model inference in a terminal. In addition, FIG. 10 is a view illustrating a method of performing AI/ML-based model training, which is applicable to the present disclosure, in a network and model inference in a network and a terminal.

Referring to FIG. 9, to use an AI/ML model that is capable of being trained through cell information, a network may collect various information from terminals. Based on the information collected from the terminals, the network may deploy a model that has finished primary training, validation and testing through offline learning. The network needs to share the deployed AI/ML model with terminals within a cell. As an example, the network may share the deployed AI/ML model with the terminals within the cell through synchronization and thus enable the terminals to operate through the same model. Herein, when the model needs to be updated through model performance feedback or additional information (e.g. UE behavior such as RLF, BFR, etc.), the network may update the model and then share the updated AI/ML model with the terminals again. As an example, the model update may also include online learning at the network side. A terminal having capability for AI/ML within a cell may perform communication based on a received AI/ML model and thus perform enhanced communication.

Referring to FIG. 9, a base station 920 may share information on an AI/ML model, which is deployed based on model training, with a terminal 910. Herein, the terminal 910 may derive an output through model inference of the shared AI/ML model and perform an action corresponding thereto, which is the same as described above. Then, the terminal 910 may provide feedback on model performance to the base station 920, and the base station 920 may share the AI/ML model, which is updated after model training based on the feedback information, with the terminal 910.

In addition, referring to FIG. 10, the base station 1020 may share information on an AI/ML model, which is deployed based on model training, with a terminal 1010. Herein, the terminal 1010 may derive an output through model inference of the shared AI/ML model. In addition, the base station 1020 may also derive an output through model inference of the same AI/ML model. Then, the terminal 1010 and the base station 1020 may perform an action based on the outputs for model inference, which is the same as described above. Then, the terminal 1010 may provide feedback on model performance to the base station 1020, and the base station 1020 may share the AI/ML model, which is updated after model training based on the feedback information, with the terminal 1010.

Referring to FIG. 9 and FIG. 10 described above, a terminal needs to receive AI/ML model information. The terminal needs to obtain cell-specific AI/ML model information from a network and needs a method for obtaining the cell-specific AI/ML model information. Herein, the terminal may obtain the AI/ML model information through a system information block (SIB) that is broadcast by a base station. However, when AI/ML model information is broadcast through an SIB, every AI/ML model information needs to be included in a broadcast message. Accordingly, as the number of AI/ML model information to be transmitted increases, a terminal may be subject to more reception burden.

As another example, a base station may provide AI/ML model information to a terminal, which requests the AI/ML model information, through a unicast message. In case a unicast message is used to share an AI/ML model, the number of the unicast message may increase along with increase in the number of terminals. Accordingly, signaling overhead and resource consumption may increase. Accordingly, a method for efficiently sharing AI/ML model information by a base station with a terminal may be needed, which will be described below:

In case a plurality of AI/ML models are trained at a network side and a terminal performs model inference using an AI/ML model that is trained at the network side, the terminal needs to efficiently receive information on the AI/ML model that is trained at the network side. Herein, the network may group the AI/ML models. As an example, the network may perform grouping of the AI/ML models based on a policy that is determined in the network, and this may be as shown in Table 3 below. Specifically, the AI/ML models may be grouped based on models with at least one of data affecting performance evaluation of the AI/ML models and a performance evaluation value being identical. As another example, the AI/ML models may be grouped according to a model type (e.g. DNN, RNN, etc.). As another example, the AI/ML models may be grouped according to coefficient quantization levels of the AI/ML models (e.g. 8 bit, 16 bit, etc.). As another example, the AI/ML models may be grouped based on at least any one of a use case, a procedure, and a processing block. As another example, the AI/ML models may be grouped according to AI/ML-related capability/version. In addition, the AI/ML models may be grouped based on a combination of the above-described grouping methods but are not limited to a specific embodiment. Then, the network may transmit AI/ML models included in a same group to the terminal through a single message.

TABLE 3
- Grouping of models with at least one of data affecting performance
evaluation of AI/ML models or a performance evaluation value being
identical
- Grouping according to AI/ML model type (e.g., DNN, RNN, etc.)
- Grouping according to AI/ML model coefficient quantization level
(e.g., 8 bit, 16 bit, etc.)
- Grouping of models with same use case/procedure/processing block
- Grouping according to AI/ML-related capability/version

Based on Table 3 described above, AI/ML models belonging to a same group may be transmitted from a base station to a terminal through a single message. Herein, the base station may also indicate whether or not update is to be performed according to each AI/ML model group. An AI/ML model group may mean a set of one or more AI/ML models that infer one or more outputs different from each other.

A message for sharing AI/ML model information based on an AI/ML model group may be configured based on a two-layered structure. Specifically, a message for sharing AI/ML model information based on an AI/ML model group may consist of a first message and a second message, and the above-described message may not be limited to a specific name. The first message may include AI/ML model group information and scheduling information for transmitting the second message according to each group. As an example, the first message may be configured as any one of SIBs or be configured as a new broadcast message but is not limited to a specific embodiment. The new broadcast message may have a new message format with a new radio network temporary identifier (RNTI) for transmitting AI/ML-related information. As an example, the first message may be a RRC message and be repeatedly transmitted based on a preset period or be transmitted at a request of a terminal.

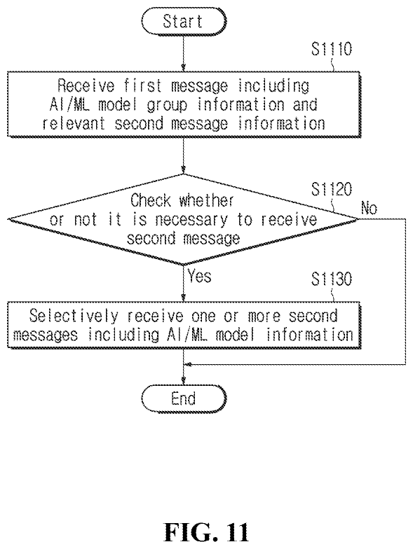

As a concrete example, FIG. 11 is a view illustrating a method of transmitting a first message that is applicable to the present disclosure. Referring to FIG. 11, a terminal may receive a first message, which includes AI/ML model group information and second message information related to an AI/ML model group, from a base station (S1110). Herein, the terminal may check whether or not it is necessary to receive a second message (S1120). As an example, in case the terminal needs to receive the second message, the terminal may selectively receive one or more second messages including the AI/ML model information (S1130). On the other hand, in case the terminal does not need to receive the second message, the terminal may not use the information included in the first message. Herein, the first message may include at least any one piece of information in Table 4 below. Specifically, the first message may include the number of groups and index information of each group. Herein, the number of groups may be the same as the number of the second message. In addition, as an example, the first message may include information indicating whether or not update is to be performed according to each group. Herein, the information indicating whether or not update is to be performed according to each group may be version information for an AI/ML model group or 1-bit change indication information for each group. That is, for n groups, the 1-bit change indication information for each group may be set to n bits. In addition, the first message may include information on a valid area for each group. Herein, the valid area may be a public land mobile network (PLMN), a cell group area, and a cell-specific area, but may not be limited to a specific embodiment. In addition, the first message may include resource scheduling information for the second message that is transmitted according to each AI/ML model group. As a concrete example, the resource scheduling information for the second message may include at least any one of transmission window information and information indicating a transmission occasion. As an example, the transmission window information may be transmission window size information. In addition, the information on the transmission occasion may include at least any one of a transmission period and offset information but is not limited to a specific embodiment.

TABLE 4
- Number of groups (second message) and index information for each
group
- Information indicating whether or not update is to be performed
according to each group (e.g., version information for AI/ML mode group
or 1-bit change indicator for each group (for n groups, n-bit change
indicator)
- Valid area information for each group (e.g., valid PLMN, cell group
area, cell only, etc.)
- Resource scheduling information for second message that is transmitted
according to each AI/ML model group (e.g., transmission window
information (window size) or information indicating a transmission
occasion (period, offset information)

In addition, as an example, a second message may mean information on a specific AI/ML group and include at least any one piece of information in Table 5 below. Specifically, the second message may include information on the number of AI/ML models included in the AI/ML model group. In addition, the second message may include index information for each AI/ML model. As an example, an AI/ML model may be applied to a specific procedure or function. Herein, the AI/ML model may be linked with a specific RRC information element (IE) based on index information of the AI/ML model. That is, definition of a function or procedure for replacing or using the AI/ML model may be indicated by an AI/ML model index in the RRC IE. In addition, the second message may include feedback information related to model performance.

TABLE 4
- Number of AI/ML modes included in a group
- Index information for each AI/ML model
e.g., an AI/ML model may be applied to a specific procedure or
function, and the AI/ML model may be linked with a specific RRC
information element (IE) by using corresponding index information.
That is, definition of a function/procedure for replacing or using
the AI/ML model may be indicated by an AI/ML model index in the
RRC IE.
- Feedback information related to model performance

That is, a terminal may obtain AI/ML model information by receiving a first message and a second message based on AI/ML model grouping. Herein, in case grouping according to AI/ML capability/version is used together with another grouping scheme, the grouping schemes may be used in a layered structure. Specifically, after a first message is transmitted, a message for each group according to AI/ML-related capability and version may be transmitted as a second message. Then, an additional third message according to additional grouping information may be transmitted. That is, a message may be transmitted by being split, and thus a message with a layered structure may be configured, and a model information exchange technique based on a grouping method with a layered structure may be used in various combinations.

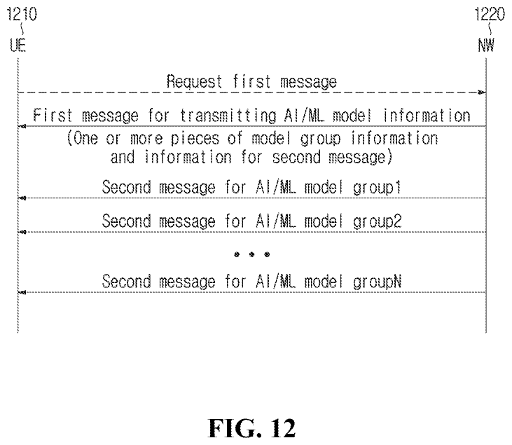

As an example, FIG. 12 is a view illustrating a method of transmitting an AI/ML model group-based message that is applicable to the present disclosure. Referring to FIG. 12, a terminal 1210 may request a network 1220 to transmit a first message. As an example, as described above, the first message may also be transmitted as a broadcast message without request and is not limited to a specific embodiment. Next, the network 1220 may transmit the first message for transmitting AI/ML model information to the terminal 1210. Herein, the first message may include one or more pieces of model group information and scheduling information for a second message, as described in Table 4 above. Next, the network 1220) may transmit the second message corresponding to each AI/ML model group to the terminal 1210 based on information on the second message included in the first message, and the second message may be as shown in Table 5.

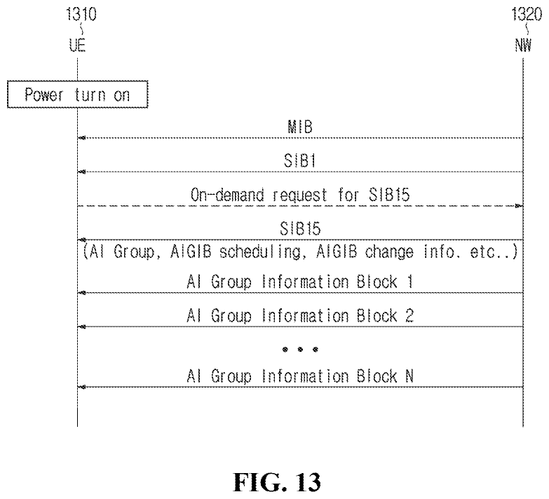

As another example, FIG. 13 is a view illustrating a method of obtaining AI/ML model information when a terminal applicable to the present disclosure initially enters a cell. As an example, in FIG. 13, for convenience of explanation, a first message is configured as one of SIBs but may not be limited thereto. Referring to FIG. 13, in case a terminal 1310 initially enters a cell, the terminal 1310 may receive basic system information (master information block (MIB), SIB1) that is broadcast from a network 1320. As an example, the terminal 1310, which supports AI/ML, may perceive, through the system information, that a base station 1320 supports AI/ML, and thus request to transmit AI/ML model information. Herein, the terminal 1310 may determine whether or not a network transmits an SIB-x (first message) including the AI/ML model information. Next, the terminal 1310 may receive the SIB-x. Herein, based on a policy of the network 1320, the terminal 1310 may receive the SIB-x by a broadcast scheme based on scheduling information for the SIB. As another example, the terminal 1310 may receive the SIB-x through an on-demand request, and in the above-described case, the SIB-x may not be broadcast. The terminal 1310 may perceive information on each AI/ML mode group through the SIB-x. In case the terminal 1310 initially enters, the terminal 1310 may obtain AI/ML model group information and scheduling information for one or more AI group information blocks in order to receive every AI/ML model information. As an example, an AI group information block may be the above-described second message. Based on the obtained scheduling information for the AI group information blocks, the terminal 1310 may receive all the one or more AI group information blocks.

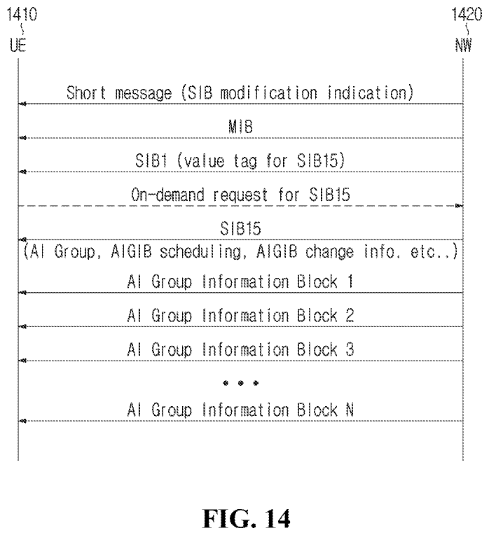

As another example. FIG. 14 is a view illustrating an operation of receiving updated AI/ML model information by a terminal that has once received AI/ML model information that is applicable to the present disclosure. As an example, in FIG. 14, for convenience of explanation, a first message is configured as one of SIBs but may not be limited thereto. Referring to FIG. 14, a terminal 1410 may identify whether not an SIB is modified, by receiving a short message from a network 1420. Herein, the short message may be a message for indicating SIB modification. As an example, in case SI modification indicates a change to a first value, the terminal 1410 may identify, through an SIB 1, whether or not an SIB-x is updated. As an example, through a value tag, the terminal 1410 may identify whether or not the SIB-x is updated. Herein, in case the SIB-x is updated, the terminal 1410 may receive the SIB-x. Based on a policy of the network 1420, the terminal 1410 may receive the SIB-x by a broadcast scheme based on scheduling information for the SIB. As another example, the terminal 1410 may receive the SIB-x through an on-demand request, and in the above-described case, the SIB-x may not be broadcast. Through the SIB-x, the terminal 1410 may perceive information on each AI/ML model group. In case the terminal 1410 has received AI/ML model information once, the terminal 1410) may obtain updated model group information through update information for each model group. In addition, the terminal 1410) may obtain scheduling information of AI group information blocks (second message) for a model group corresponding to the updated model group information. Next, based on scheduling information for AI group information blocks that are determined to require update or new reception, the terminal 1410 may selectively receive one or more AI group information blocks.

As another example, information on an AI/ML model may be defined not as an SIB but as a message with a new form. As an example, for information on an AI/ML model group, a first message may be defined not as an SIB but as a new message. Herein, whether or not information on the first message is modified or whether or not information on one or more second messages is modified may be included in a short message or new downlink control information (DCI) but is not limited to a specific embodiment. Herein, a terminal, which has received AI/ML model information once, may identify whether or not update is performed, through an update indicator field for a first message or a second message in a short message or new DCI. That is, unlike the above-described SIB procedure, the terminal may identify whether or not an AI/ML model is updated, through a short message or new DCI. Herein, in case whether or not the first message is updated is notified within the short message or new DCI, 1-bit AI/ML model information update indicator may be configured. Herein, if the 1-bit AI/ML model information update indicator has a first value, the terminal may perceive that the AI/ML model is updated and then attempt to receive the first message. The terminal may receive update information for each AI/ML model group through the first message and receive only an updated second message.

As another example, in case whether or not one or more second messages are updated is notified within a short message or new DCI, an n-bit update indicator may be used for N AI/ML models. In case a corresponding value is a first value, a terminal may perceive update for an AI/ML model and attempt to selectively receive a second message (or messages) for a corresponding AI/ML model group. That is, the terminal may identify AI/ML model update information directly through the short message or new DCI, and the terminal may use a first message and scheduling information for a second message as they are stored after being first received.

As another example, in the above-described case, an AI/ML model may include valid area information for each group. The valid area information for each group of the AI/ML model may be transmitted in a first message. That is, the valid area information for an AI/ML model may be defined according to each group. As an example, a terminal, which receives the first message including the valid area information for each group of the AI/ML model, may determine whether or not an area is valid for a specific group, whenever moving to a cell. In case the terminal determines that it is out of a valid area for a specific AI/ML model group, the terminal may newly update only a corresponding AI/ML model. Herein, the above-described operation may be performed by the terminal without any instruction from a base station. That is, the terminal may selectively receive only information on a group that needs new reception, based on existing area information that the terminal received.

Through the above description, in a wireless communication environment where a plurality of AI/ML models are shared, a terminal may efficiently receive an AI/ML model from a network. Especially, in case there is an AI/ML model that is being updated, the terminal may selectively receive only updated AI/ML models, so that reception burden on the terminal may be reduced.

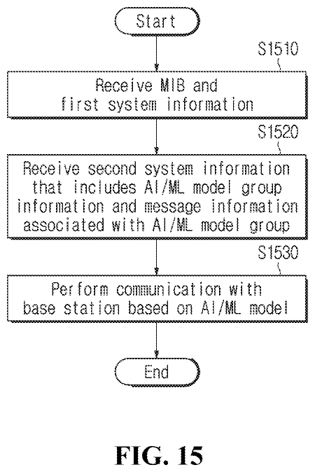

FIG. 15 is a view illustrating an operation of a terminal that is applicable to the present disclosure. Referring to FIG. 15, the terminal may receive an MIB and first system information from a base station (S1510). Herein, the first system information may be an SIB 1 but is not limited to a specific embodiment. Next, the terminal may receive second system information that includes AI/ML model group information and message information related to an AI/ML model group (S1520). Herein, the second system information may be the above-described first message. As another example, the second system information may be the above-described SIB-x but is not limited to a specific embodiment. In addition, the message related to the AI/ML model group may be a second message. That is, for each AI/ML model group, the terminal may determine, based on the second system information, whether or not a message related to the each AI/ML model group is received. Next, the terminal may perform communication with the base station based on the AI/ML model (S1530).

Herein, as an example, the AI/ML model group information included in a second system information block may include at least any one of AI/ML model group number information, index information according to each AI/ML model group, update indication information according to each AI/ML model group, valid area information according to each AI/ML model group, and resource scheduling information for a message related to an AI/ML model group. That is, the AI/ML model group information included in the second system information block may be as described in Table 4 above but may not be limited thereto. Herein, the number of AI/ML model groups may be the same as the number of messages related to the AI/ML model groups. That is, as many second messages as the number of AI/ML model groups may be configured. In addition, the update indication information according to each AI/ML model group may be set to 1 bit for each AI/ML model group and thus be set to bits corresponding to the number of AI/ML model groups. That is, if the number of AI/ML model groups is n, n-bit indication information may be configured. In addition, the valid area information according to each AI/ML model group may be indicated based on at least any one of a PLMN cell group area and a cell. As an example, in case a terminal moves into a cell, the terminal may determine a valid area for each AI/ML model group. Herein, the terminal may perform AI/ML model group update only for an AI/ML model group that goes out of a valid area, which is the same as described above.

In addition, the resource scheduling information for a message related to an AI/ML model group may include at least any one of transmission window information and transmission occasion information where the message related to the AI/ML model group. That is, resource scheduling information related to second message transmission may be included. Herein, a size of a transmission window may be indicated based on the transmission window information, and a transmission period and a transmission offset value may be indicated based on the transmission occasion information, and this is the same as described above.

In addition, the terminal may receive a message related to at least one or more AI/ML model groups based on message information related to AI/ML model groups. That is, the terminal may determine whether or not to receive a second message for each AI/ML model group and receive a second message by a resource configured for an AI/ML model group for the second message needs to be received. Herein, the message related to the AI/ML model group (second message) may include at least any one of the number of AI/ML models in the AI/ML model group, an index of each AI/ML model in the AI/ML model group, and feedback information related to AI/ML model performance. Herein, based on the index of each AI/ML model in the AI/ML model group, each AI/ML model and a radio resource control (RRC) information element (RE) may be connected to each other.

In addition, as an example, an AI/ML model group may be grouped based on at least any one of performance evaluation data, an AI/ML model type, an AI/ML model coefficient quantization level, an AI/ML model procedure, and AI/ML capability and AI/ML version.

In case a terminal performs initial access to a cell, the terminal may obtain an MIB and a first system information block, and in case a second system information block is broadcast, the terminal may obtain the second system information block based on the first system information block, and in case the second system information block is not broadcast, the terminal may obtain the second system information block based on an on-demand request. In addition, after the terminal receives AI/ML model information, if the terminal receives at least any one of a short message and downlink control information (DCI), the terminal may receive the second system information block. Herein, the short message and the DCI may include information indicating AI/ML model update. Herein, the information indicating the AI/ML model update may be configured for each AI/ML model group.

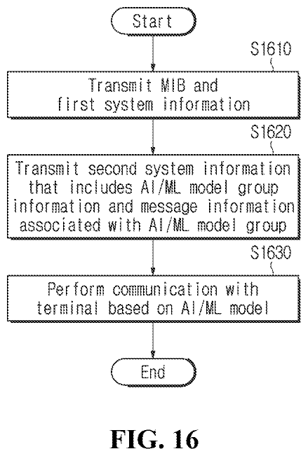

FIG. 16 is a view illustrating an operation of a base station that is applicable to the present disclosure. Referring to FIG. 16, the base station may transmit an MIB and first system information (S1610). Herein, the first system information may be an SIB 1 but is not limited to a specific embodiment. Next, the base station may transmit second system information that includes AI/ML model group information and message information related to an AI/ML model group (S1620). Herein, the second system information may be the above-described first message. As another example, the second system information may be the above-described SIB-x but is not limited to a specific embodiment. In addition, the message related to the AI/ML model group may be a second message. Thus, for each AI/ML model group, a terminal may determine, based on the second system information, whether or not a message related to the each AI/ML model group is received. Next, the base station and the terminal may perform communication based on an AI/ML model (S1630).

the AI/ML model group information included in a second system information block may include at least any one of AI/ML model group number information, index information according to each AI/ML model group, update indication information according to each AI/ML model group, valid area information according to each AI/ML model group, and resource scheduling information for a message related to an AI/ML model group. That is, the AI/ML model group information included in the second system information block may be as described in Table 4 above but may not be limited thereto. Herein, the number of AI/ML model groups may be the same as the number of messages related to the AI/ML model groups. That is, as many second messages as the number of AI/ML model groups may be configured. In addition, the update indication information according to each AI/ML model group may be set to 1 bit for each AI/ML model group and thus be set to bits corresponding to the number of AI/ML model groups. That is, if the number of AI/ML model groups is n, n-bit indication information may be configured. In addition, the valid area information according to each AI/ML model group may be indicated based on at least any one of a PLMN cell group area and a cell. As an example, in case a terminal moves into a cell, the terminal may determine a valid area for each AI/ML model group. Herein, the terminal may perform AI/ML model group update only for an AI/ML model group that goes out of a valid area, which is the same as described above.

In addition, the resource scheduling information for a message related to an AI/ML model group may include at least any one of transmission window information and transmission occasion information where the message related to the AI/ML model group. That is, resource scheduling information related to second message transmission may be included. Herein, a size of a transmission window may be indicated based on the transmission window information, and a transmission period and a transmission offset value may be indicated based on the transmission occasion information, and this is the same as described above.

In addition, the terminal may receive a message related to at least one or more AI/ML model groups based on message information related to AI/ML model groups. That is, the terminal may determine whether or not to receive a second message for each AI/ML model group and receive a second message by a resource configured for an AI/ML model group for the second message needs to be received. Herein, the message related to the AI/ML model group (second message) may include at least any one of the number of AI/ML models in the AI/ML model group, an index of each AI/ML model in the AI/ML model group, and feedback information related to AI/ML model performance. Herein, based on the index of each AI/ML model in the AI/ML model group, each AI/ML model and a radio resource control (RRC) information element (RE) may be connected to each other.

In addition, as an example, an AI/ML model group may be grouped based on at least any one of performance evaluation data, an AI/ML model type, an AI/ML model coefficient quantization level, an AI/ML model procedure, and AI/ML capability and AI/ML version.

In case a terminal performs initial access to a cell, the terminal may obtain an MIB and a first system information block, and in case a second system information block is broadcast, the terminal may obtain the second system information block based on the first system information block, and in case the second system information block is not broadcast, the terminal may obtain the second system information block based on an on-demand request. In addition, after the terminal receives AI/ML model information, if the terminal receives at least any one of a short message and downlink control information (DCI), the terminal may receive the second system information block. Herein, the short message and the DCI may include information indicating AI/ML model update. Herein, the information indicating the AI/ML model update may be configured for each AI/ML model group.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method performed by a terminal in a wireless communication system, the method comprising:
receiving, by the terminal, a master information block (MIB) from a base station;
obtaining a first system information block based on the received MIB;
obtaining a second system information block based on the first system information block; and
performing communication with the base station based on the second system information block,
wherein the second system information block includes artificial intelligence (AI)/machine learning (ML) model group information and message information related to an AI/ML model group.

2. The method of claim 1, wherein the AI/ML model group information included in a second system information block includes at least any one of AI/ML model group number information, update indication information per AI/ML model group, valid area information per AI/ML model group, and resource scheduling information for a message related to the AI/ML model group.

3. The method of claim 2, wherein an AI/ML model group number is equal to the number of the message related to the AI/ML model group, and
wherein the update indication information per AI/ML model group is set to 1 bit for each AI/ML mode group and thus be set to a bit corresponding to the AI/ML model group number.

4. The method of claim 2, wherein the valid area information per AI/ML model group is indicated based on at least any one of a public land mobile network (PLMN), a cell group area, and a cell.

5. The method of claim 4, wherein based on the terminal moving into a cell, the terminal determines a valid area for each AI/ML model group, and
wherein based on at least one AI/ML model group among the AI/ML model group being outside a valid area, the terminal updates only the at least one AI/ML model group that is outside the valid area.

6. The method of claim 2, wherein the resource scheduling information for the message related to the AI/ML model group includes at least any one of transmission window information and transmission occasion information in which the message related to the AI/ML model group is transmitted,
wherein a size of a transmission window is indicated based on the transmission window information, and
wherein a transmission period and a transmission offset value are indicated based on the transmission occasion information.

7. The method of claim 1, wherein the terminal receives a message related to at least one or more AI/ML model groups based on the message information related to the AI/ML model group, and
wherein the message related to the AI/ML model group includes at least any one of the number of AI/ML models in the AI/ML model group, an index of each AI/ML model in the AI/ML model group, and feedback information related to AI/ML model performance.

8. The method of claim 7, wherein based on the index of the each AI/ML model in the AI/ML model group, the each AI/ML model and a radio resource control (RRC) information element (IE) are connected.

9. The method of claim 1, wherein the AI/ML model group is grouped based on at least any one of performance evaluation data, an AI/ML model type, an AI/ML model coefficient quantization level, an AI/ML model procedure, and AI/ML capability and AI/ML version.

10. The method of claim 1, wherein based on the terminal performing initial access, the terminal obtains the MIB and the first system information block,
wherein based on the second system information block being broadcast, the terminal obtains the second system information block based on the first system information block, and
wherein based on the second system information block being not broadcast, the terminal obtains the second system information block based on an on-demand request.

11. The method of claim 1, wherein based on the terminal receiving at least any one of a short message and downlink control information (DCI) after receiving AI/ML model information, the terminal receives the second system information block, and the short message and the DCI include information indicating update of the AI/ML model.

12. The method of claim 11, wherein the information indicating the update of the AI/ML model is configured according to each AI/ML model group.

13. A method performed by a base station in a wireless communication system, the method comprising:
transmitting, by the base station, a master information block (MIB);
transmitting a first system information block based on the MIB;
transmitting a second system information block based on the first system information block; and
performing communication with a terminal based on the second system information block,
wherein the second system information block includes artificial intelligence (AI)/machine learning (ML) model group information and message information related to an AI/ML model group.

14. A terminal in a wireless communication system, the terminal comprising:
a transceiver; and
a processor coupled with the transceiver,
wherein the processor is configured to:
receive a master information block (MIB) from a base station by using the transceiver,
obtain a first system information block based on the received MIB by using the transceiver,
obtain a second system information block based on the first system information block by using the transceiver, and
perform communication with the base station based on the second system information block, and
wherein the second system information block includes artificial intelligence (AI)/machine learning (ML) model group information and message information associated an AI/ML model group.

15-17. (canceled)
